(19) United States
(12) Patent Application Publication
(10) Pub. No.: US 2006/0146699 A1
(43) Pub. Date: Jul. 6, 2006

(54) Communication system, in particular for making announcements and providing communication between two voice terminals in a multi-car train set

(75) Inventors: Jurgen Sept, Wolkersdorf (DE); Otto Stanin, Stein (DE)

Correspondence Address: Henry M. Feiereisen;Henry M. Feiereisen, LLC, Suite 4714, 350 Fifth Avenue, New York, NY, 10118, US

(73) Assignee: Siemens Aktiengesellschaft, Munchen (DE)

(21) Appl. No.: 11/284,302

(22) Filed: Nov. 21, 2005

(30) Foreign Application Priority Data
Nov. 25, 2004 (DE) 10 2004 057 458.8

(51) Int. Cl. G05D 1/00

(52) U.S. Cl. 370/221; 701/19

(57) ABSTRACT

A communication system for providing communication between terminals in a train, for example a passenger train with several railcars, includes a communication bus extending along the length of the train and including a flame-retardant cable. One or more communication devices, in particular communication terminals, such as voice terminals, are arranged in the railcars. Fire-resistant switches associated with the communication devices connect the communication devices to the communication bus. The fire-resistant switches are designed to automatically disconnect the communication devices from the communication bus in the event of a fire so as to maintain operation of the communication system.

### CROSS-REFERENCES TO RELATED APPLICATIONS

This application claims the priority of German Patent Application, Serial No. 10 2004 057 458.8, filed Nov. 25, 2004, pursuant to 35 U.S.C. 119(a)-(d), the subject matter of which is/are incorporated herein by reference.

### BACKGROUND OF THE INVENTION

The present invention relates to a communication system, in particular for making announcements and providing communication between two voice terminals in a multi-car train set.

Nothing in the following discussion of the state of the art is to be construed as an admission of prior art.

Communication systems in passenger trains are generally used for conveying information to the passengers, in particular for announcing the next station stop and train connections at that stop. The announcements are made via several loudspeakers which may be installed in the ceiling of each car and connected to corresponding amplifiers. The announcements are either initialized manually from voice terminals installed in the train or made automatically, whereby stored contents may also be conveyed. In addition to making announcements, the communication system also enables communication between train conductors and between the train engineer and train conductors. This is accomplished by installing voice terminals in the passenger compartment and/or near the console of the train engineer.

To implement a communication system for carrying out these announcements or communications, a bus is provided in the form of parallel cables which are routed along the length of the entire train, with the voice terminals for information input and output being connected to these cables. For safety reasons, these cables are provided with a flame-retardant insulation, which in the event of a fire ensures complete functionality of the bus for a predetermined time. During the announcement or communication, the information is always transmitted in the direction to the devices operating as terminals.

A drawback of conventional communication systems is the damage or even destruction that can be encountered in the event of fire so that the transmission of information is adversely affected. In general, communication systems need to remain operational for at least 30 minutes in the event of a fire, with the exception of the system in the car which is on fire.

In particular, devices connected to the bus can severely impair the functionality of the communication system, so that the communication throughout the entire train set can fail.

It would therefore be desirable to provide a communication system to obviated prior art shortcomings and to ensure operation of the communication system in the event of a fire, even in the event of destruction of communication devices in the system.

### SUMMARY OF THE INVENTION

According to one aspect of the invention, a communication system for a train having several railcars includes a communication bus extending along the train and including a flame-retardant cable, a communication device arranged in the railcars for transmission of received information, and a fire-resistant switch connecting the communication device to the communication bus and constructed to automatically disconnect the communication device from the communication bus in the event of a fire.

The present invention resolves prior art problems by the absence of a direct connection between the individual communication devices and the bus, and the incorporation of a special switch by which the communication devices are connected to the bus. The flame retardant cables of the bus and the fireproof switch temporarily protect the entire “backbone region” of the communication system from the fire.

According to another feature of the present invention, the train is a passenger train. Suitably, the communication device is a voice terminal, whereby the communication system is used for announcement of information and communication between two such voice terminals.

According to another feature of the present invention, the switch may be arranged inside a housing that is formed of a flame-retardant heat resistant material, with the cables of the bus, of the corresponding communication device and of the fire detector terminating in the housing. This configuration is simple in structure.

According to another feature of the present invention, the switch may be constructed to mechanically and electrically disconnect the communication device from the bus.

The switch can be activated in two ways: by a separate fire detector and through detection of a fire by the associated communication device.

By employing a flame-retardant housing for the switch, the switch can be constructed from inexpensive standard components.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a communication system of a passenger train with fire-proof switches; and

FIG. 2 shows schematically the configuration of the switch implemented as a disconnect switch.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

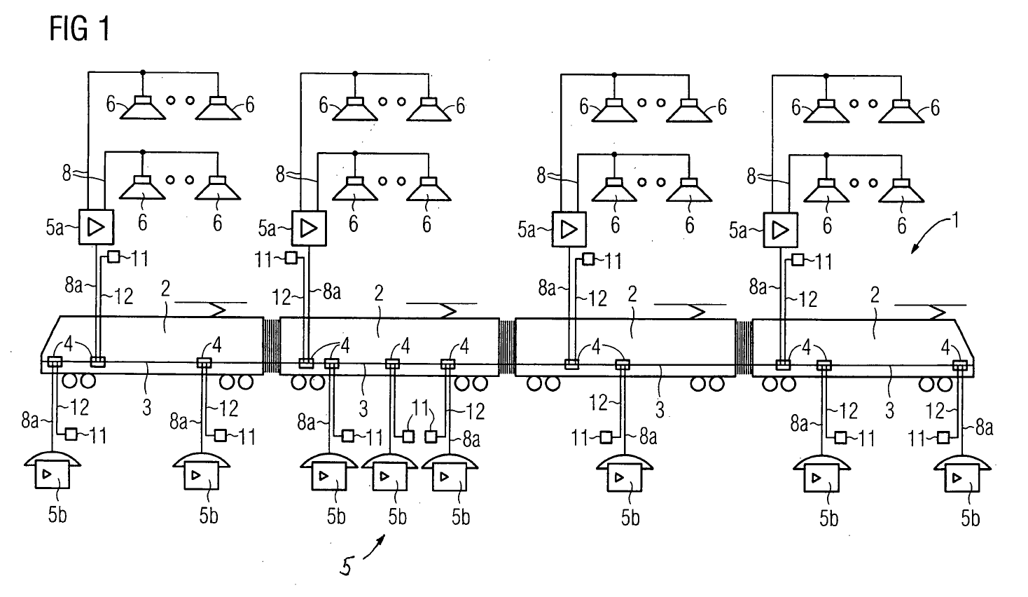

Turning now to the drawing, and in particular to FIG. 1, there is shown a communication system for transmitting information inside a passenger train 1 having several railcars 2. A communication bus 3 extends along the length of the passenger train 1, whereby the bus 3 is formed of several parallel cables (not shown) which are provided with a flame-retardant insulation and are enclosed in an outer jacket which is also flame-retardant. A plurality of terminals, generally designated by reference numeral 5, are connected by cables 8a to respective fireproof switches 4 which are arranged on the bus 3. Each of the terminals 5 may be constructed as an amplifier 5a and/or a voice terminal 5b. Several loudspeakers 6 for making announcements and conveying other information are connected to the amplifiers 5a via corresponding cables 8. It will be understood that other types of terminals 5 can be connected to the switches 4, for example microphones or electronic storage devices (for automatic announcements). The microphones can be used for voice input of information and messages intended for the respective recipients.

FIG. 1 also shows fire detectors 11 placed along the entire length of the train in proximity of the terminals 5 to be protected. The fire detectors 11 are also connected to the corresponding switches 4 via fireproof cables 12. In the event of a fire, the fire detectors 11 provide a signal with which the switch box of the corresponding train section can disconnect the terminals 5.

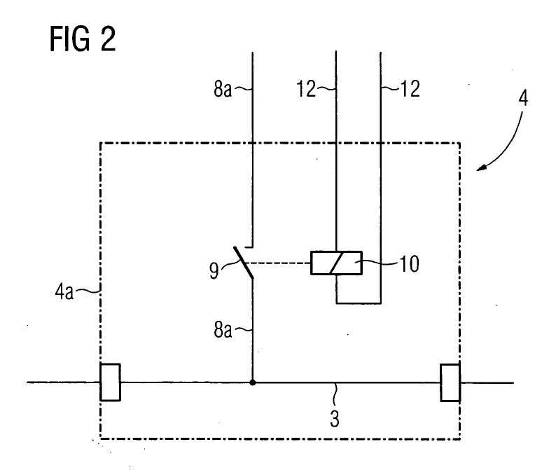

FIG. 2 is a schematic diagram of the fireproof switch 4 in the form of a disconnect box having a housing 4a. The bus 3 is routed through the sidewalls of the housing 4a of the disconnect box and connected to the switch 4. The disconnect box is also constructed of a flame-retardant, fireproof material. A branch cable 8a is shown by way of example to extend from the bus 3 to one of the terminals 5. The branch cable 8a can be disconnected by releasing a make contact 9 of a relay 10. For this purpose, the fire detector 11 of a fire detection system generates a voltage signal which switches the relay 10 and disconnects the branch cable 8 accordingly. The connected terminal 5 is then electrically disconnected in the event of a fire. As a result, the destruction of a terminal 5 by the fire has no adverse effect on the bus 3 so that the operativeness of the communication system is maintained. The disconnect box itself can include inexpensive standard components.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed is:

1. A communication system for a train having several railcars, comprising:
a communication bus extending along the train and including a flame-retardant cable;
a communication device arranged in the railcars for transmission of received information; and
a fire-resistant switch connecting the communication device to the communication bus and constructed to automatically disconnect the communication device from the communication bus in the event of a fire.

2. The communication system of claim 1, wherein the train is a passenger train.

3. The communication system of claim 1, wherein the communication device is a voice terminal, said communication device being used for announcement of information and communication between at least two of said voice terminal.

4. The communication system of claim 1, further comprising a plurality of said communication device and a plurality of said switch, wherein the communication devices and the switches are placed into one-to-one correspondence.

5. The communication system of claim 1, further comprising a housing made of flame-retardant, heat-resistant material and accommodating the switch, and a fire detector connected to the switch by a cable, said housing being constructed to receive the cable connected between the fire detector and the switch, a cable connected between the communication device and the switch, and the cable of the communication bus.

6. The communication system of claim 1, wherein the switch is constructed to mechanically and electrically separate the communication device from the communication bus.

7. The communication system of claim 2, wherein the switch is constructed to respond to a signal transmitted from the fire detector.

8. The communication system of claim 1, wherein a switch is constructed to respond to a fire detected by the communication device.

9. The communication system of claim 1, wherein the switch is made of standard components.
